(19) United States
(12) Patent Application Publication
(10) Pub. No.: US 2018/0003127 A1
(43) Pub. Date: Jan. 4, 2018

(54) ENGINE AND METHOD OF MANUFACTURING CYLINDER BLOCK OF ENGINE

(71) Applicant: YAMAHA HATSUDOKI KABUSHIKI KAISHA, Iwata-shi (JP)

(72) Inventor: Kenichi SAKURAI, Shizuoka (JP)

(21) Appl. No.: 15/640,634

(22) Filed: Jul. 3, 2017

(30) Foreign Application Priority Data
Jul. 4, 2016 (JP) 2016-132243

(51) Int. Cl. F02F 7/00; B23C 3/12; F02F 1/18

(52) U.S. Cl. CPC F02F 7/0095; F02F 1/18; F02F 7/0019; B23C 3/12; B23C 2210/202; B23C 2215/24; F02F 2200/06; B23C 2220/16

(57) ABSTRACT

An engine includes a cylinder block including a cylinder hole, a crank shaft as an offset crank, and a connecting rod that connects the piston and the crank shaft. An inclined surface is provided on an entire circumference of a crank-shaft-side opening edge of one end of the cylinder hole. When viewed in the axial direction of the crank shaft, a boundary line between the inclined surface and the cylinder hole extends towards the other end of the cylinder hole as it extends toward an offset side on which the crank shaft is offset from the center axis of the cylinder hole. The offset crank engine has the entire circumference of the crank-shaft-side opening edge of the cylinder hole chamfered without any bad influence on the sliding surface and posture of the piston to avoid interference between the crank-shaft-side opening edge of the cylinder hole and the connecting rod.

### CROSS REFERENCE TO RELATED APPLICATIONS

This application claims the benefit of priority to Japanese Patent Application No. 2016-132243 filed on Jul. 4, 2016. The entire contents of this application are hereby incorporated herein by reference.

### BACKGROUND OF THE INVENTION

### 1. Field of the Invention

The present invention relates to an engine in which a honing stone escape portion is provided in a cylinder block, and a method of manufacturing the cylinder block of the engine.

### 2. Description of the Related Art

Conventionally, a cylinder hole of an engine is processed by honing. The honing process is performed by moving a honing stone rotating in the cylinder hole back and forth along the center axis of the cylinder hole. During the honing, the honing stone extends through the cylinder hole and projects by a predetermined length into a crank chamber from the cylinder hole. The honing stone should project into the crank chamber in order to evenly polish the cylinder hole over the entire length, thus increasing the precision of the cylindricality of the cylinder hole.

A cylinder block of a multi-cylinder engine includes a cylinder wall with a cylinder hole, a crank case that defines a crank chamber together with an oil pan, and a bearing wall that extends toward a crank shaft from the ceiling wall of the crank case between cylinders. A cylinder-side half of a bearing that supports the crank shaft is provided on the distal end of the bearing wall.

In a recent multi-cylinder engine, the cylinder spacing is narrowed as much as possible in order to achieve downsizing in the axial direction of the crank shaft. Therefore, the above-described bearing wall is often positioned close to the cylinder hole. When an engine cylinder block like this is formed by aluminum die casting, the bearing wall partially overlaps the cylinder hole when viewed in a direction parallel to the center axis of the cylinder. This is because the whole bearing wall has a thickness of a bearing portion having the largest thickness so that the bearing wall is releasable from the metal mold, since, in aluminum die casting, a molten metal is injected into a metal mold at such a high speed and high pressure that it is difficult to use a sand core.

If the bearing wall extends toward the cylinder hole as described above, the honing process cannot be performed without also performing a honing stone escape process on the bearing wall, as described in, for example, Japanese Patent Laid-Open No. 2015-161189. As shown in FIG. 14, the honing stone escape process is performed by using a rotary cutting tool 101. FIG. 14 is a sectional view showing a portion of a cylinder block 102 in an enlarged scale. In FIG. 14, reference numeral 103 denotes a cylinder hole; and 104, a bearing wall positioned between cylinders. The honing stone escape process is performed by inserting a rotary cutting tool 101 between the bearing walls 104, and rotating the rotary cutting tool 101 held in a predetermined position. The rotary cutting tool 101 has a retractable blade (not shown), and rotates with this blade being projected. The rotating blade cuts the bearing walls 104.

After the honing stone escape process, as shown in FIG. 15, some portions of the bearing walls 104 are partially removed to form honing stone escape portions 105 are formed as recesses on the bearing walls 104. In the honing stone escape process, as shown in FIG. 16, the rotary cutting tool 101 chamfers a crank-shaft-side opening edge of the cylinder hole 103. In the chamfering process, an inclined surface 108 is formed on the crank-shaft-side opening edge of the cylinder hole 103.

Also, some conventional multi-cylinder engines have an offset crank as a crank shaft. This offset crank is a crank shaft having an axis which is offset from the center axis of the cylinder hole. In an engine using the offset crank, a connecting rod is biased in an offset direction of the crank shaft. In the offset direction, the spacing between the crank-shaft-side opening edge of the cylinder hole and the connecting rod is narrowed, and this may cause interference.

In the conventional engine of this type, the interference between the crank-shaft-side opening edge of the cylinder hole and the connecting rod is avoided by using the following methods. Examples of the interference avoiding method include a method by which a recess that avoids the connecting rod is integrally molded by casting on the crank-shaft-side opening edge of the cylinder hole, and a method which performs casting such that the position of the crank-shaft-side opening edge of the cylinder hole is raised over the entire circumference. The recess that avoids the connecting rod is formed by using a metal mold when molding the cylinder block.

An offset crank engine poses the following problem if the method of integrally molding the recess on the crank-shaft-side opening edge of the cylinder hole by casting is used in order to avoid the interference between the crank-shaft-side opening edge of the cylinder hole and the connecting rod. That is, when the crank-shaft-side opening edge of the cylinder hole is chamfered after casting, the inclined surface becomes intermittent because of the recess, and a processing edge or burr is created in this intermittent portion.

If a piston goes back and forth in the cylinder hole with the processing edge or burr as described above, the sliding surface of the skirt of the piston is easily damaged. If the sliding surface of the piston is damaged, defective lubrication may occur and cause piston seizure.

When casting is performed such that the position of the crank-shaft-side opening edge of the cylinder hole is raised over the entire circumference in order to avoid the interference between the opening edge and the connecting rod, the guide of the piston reduces near the bottom dead center, and the posture of the piston may become unstable and generate noise.

### SUMMARY OF THE INVENTION

Preferred embodiments of the present invention provide offset crank engines in which an entire circumference of a crank-shaft-side opening edge of a cylinder hole is able to be chamfered to avoid interference between the crank-shaft-side opening edge of the cylinder hole and a connecting rod and without any adverse influence on a sliding surface and a posture of a piston. Additional preferred embodiments of the present invention provide methods of manufacturing a cylinder block of an offset crank engine.

An engine according to a preferred embodiment of the present invention includes a cylinder block including a cylinder hole into which a piston is movably fitted, a crank shaft having an axis which is offset from a center axis of the cylinder hole, and a connecting rod that connects the piston and the crank shaft to each other, wherein an inclined surface is provided on an entire circumference of a crank-shaft-side opening edge of a first end of the cylinder hole, and when viewed in an axial direction of the crank shaft, a boundary line between the inclined surface and the cylinder hole extends towards a second end of the cylinder hole as the inclined surface extends toward an offset side of the cylinder hole at which the crank shaft is offset from the center axis.

An engine cylinder block manufacturing method according to a preferred embodiment of the present invention is a method of manufacturing a cylinder block including a cylinder hole into which a piston is movably fitted, and a crank shaft having an axis offset from a center axis of the cylinder hole, the method including a chamfering step of chamfering an entire circumference of a crank-shaft-side opening edge of the cylinder hole by using a cutter which rotates around an axis parallel or substantially parallel to the center axis, wherein the chamfering is performed by moving the cutter along the crank-shaft-side opening edge, and a moving amount of a rotation center of the cutter which moves in the chamfering step is larger on a first side at which the crank shaft is offset from the center axis of the cylinder hole than on a second side, when viewed in a direction of the axis of the crank shaft.

An engine cylinder block manufacturing method according to a preferred embodiment of the present invention is a method of manufacturing a cylinder block including a cylinder hole into which a piston is movably fitted, and a crank shaft having an axis offset from a center axis of the cylinder hole, the method including a chamfering step of chamfering an entire circumference of a crank-shaft-side opening edge of the cylinder hole by using a cutter which rotates around an axis parallel or substantially parallel to the center axis, wherein the chamfering is performed in a state in which a rotation center of the cutter stays in a position biased in an offset direction of the crank shaft with respect to the center axis.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view of a cylinder block according to a preferred embodiment of the present invention.

FIG. 2 is a sectional view for explaining the arrangement of the cylinder block.

FIG. 3 is a sectional view showing main portions in an enlarged scale.

FIG. 4 is a view showing the bottom surface of a bearing wall.

FIG. 5 is a sectional view showing the bearing wall sideways.

FIG. 6 is a plan view showing a cylinder wall in a state in which a cutter according to a first preferred embodiment of the present invention is inserted.

FIG. 7 is a perspective view showing a state in which a crank-shaft-side opening edge of a cylinder hole is viewed from the side of a crank chamber.

FIG. 8 is a flowchart for explaining a cylinder block manufacturing method.

FIG. 9 is a flowchart for explaining a chamfering step according to the first preferred embodiment of the present invention.

FIG. 10 is a plan view showing a cylinder wall in a state in which a cutter according to a second preferred embodiment of the present invention is inserted.

FIG. 11 is a flowchart for explaining a chamfering step according to the second preferred embodiment of the present invention.

FIG. 12 is a sectional view showing a bearing wall according to a third preferred embodiment of the present invention sideways.

FIG. 13 is a sectional view for explaining the arrangement of a cylinder block according to a fourth preferred embodiment of the present invention.

FIG. 14 is a sectional view showing a state before an escape process is performed on a conventional bearing wall.

FIG. 15 is a sectional view showing a state after an escape process is performed on the conventional bearing wall.

FIG. 16 is a sectional view showing a state after the crank-shaft-side opening edge of a conventional cylinder hole is chamfered.

### DETAILED DESCRIPTION OF THE PREFERRED EMBODIMENTS

### First Preferred Embodiment

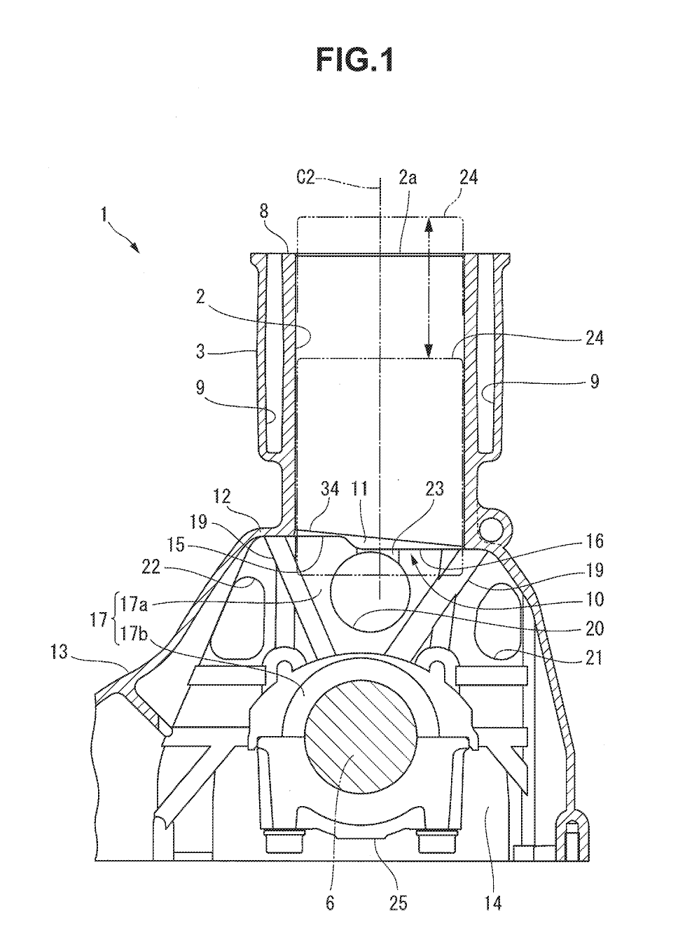

A first preferred embodiment of an engine and a method of manufacturing a cylinder block of the engine will be explained in detail below with reference to FIGS. 1 to 9.

A cylinder block 1 shown in FIG. 1 is a cylinder block of a multi-cylinder engine, for example, and is made to have a predetermined shape by, for example, gravity die casting using cast iron, for example, as a material and a sand mold or core (not shown). The cylinder block 1 includes three functional portions.

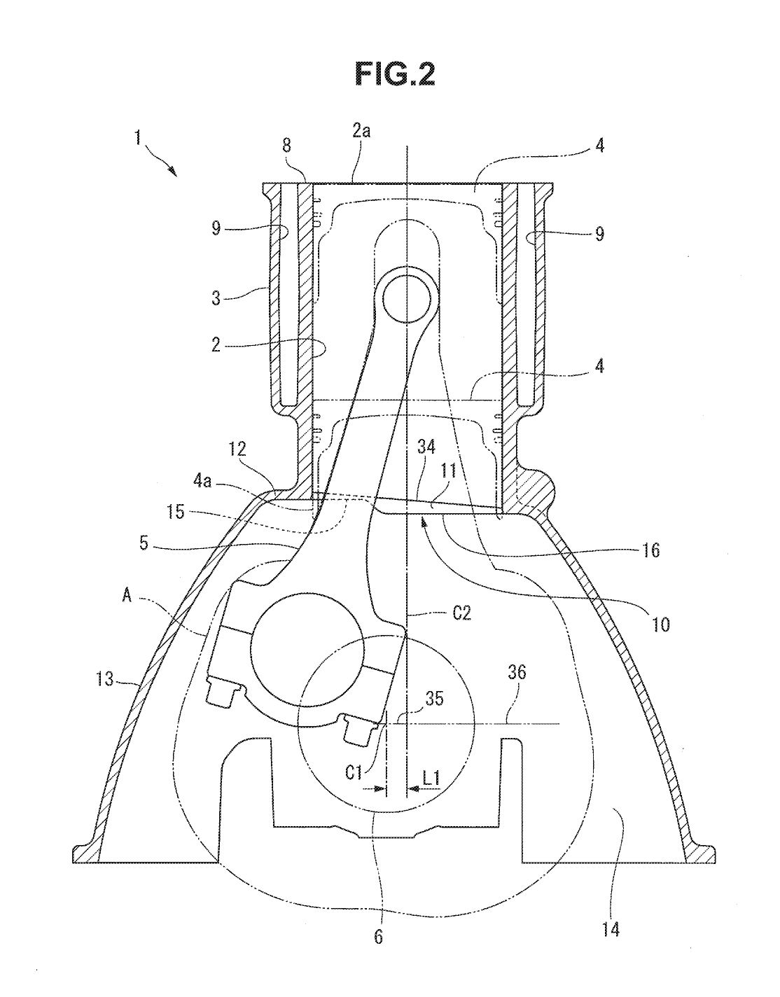

The first functional portion is a cylinder wall 3 including a plurality cylinder holes 2. As shown in FIG. 2, a piston 4 is movably fitted into the cylinder hole 2. FIG. 2 shows the piston 4 positioned at top dead center, and the piston 4 positioned at bottom dead center.

The piston 4 is connected to a crank shaft 6 by a connecting rod 5. FIG. 2 omits a crank web, crank pin, and the like of the crank shaft 6, and shows only a crank journal by the alternate long and two short dashed line.

The crank shaft 6 is a so-called offset crank. When viewed in the axial direction as shown in FIG. 2, an axis C1 of the crank shaft 6 is offset by a length L1 to one side (the left side in FIG. 2) with respect to a center axis C2 of the cylinder hole 2. Therefore, the outermost moving locus of the connecting rod 5 has a shape biased to the left side in FIG. 2, as indicated by an alternate long and two short dashed line A in FIG. 2. In the following description, one side on which the crank shaft 6 is offset will simply be called “an offset side”, and the side opposite to this direction will be called “the other side”.

A mating surface 8 to attach a cylinder head (not shown) is provided on one end (the upper end in FIG. 1) of the cylinder wall 3. An opening 2a of the cylinder hole 2, which is positioned on the side opposite to the crank shaft 6, is provided in the mating surface 8. For the sake of convenience, one end (the upper side in FIGS. 1 and 2) of the cylinder wall 3 will be called “a cylinder head side”, and the other end thereof will be called “a crank shaft side”.

A cooling water passage 9 is provided in a portion of the cylinder wall 3 that covers the cylinder hole 2.

An inclined surface 11 is formed by chamfering (to be described below) on a portion which is the crank-shaft-side end of the cylinder wall 3 and a crank-shaft-side opening edge 10 of the cylinder hole 2. Details of the chamfering will be described below. Note that the chamfering is performed before the cylinder hole 2 is honed.

The second functional portion of the cylinder block 1 is a crank case 13 including a ceiling wall 12 connected to the crank-shaft-side end of the cylinder wall 3. The crank case 13 preferably has the shape of a box which opens toward the side opposite to the cylinder wall 3. The opening of the crank case 13 is closed with an oil pan (not shown). The crank case 13 and oil pan define a crank chamber 14 that accommodates the crank shaft 6.

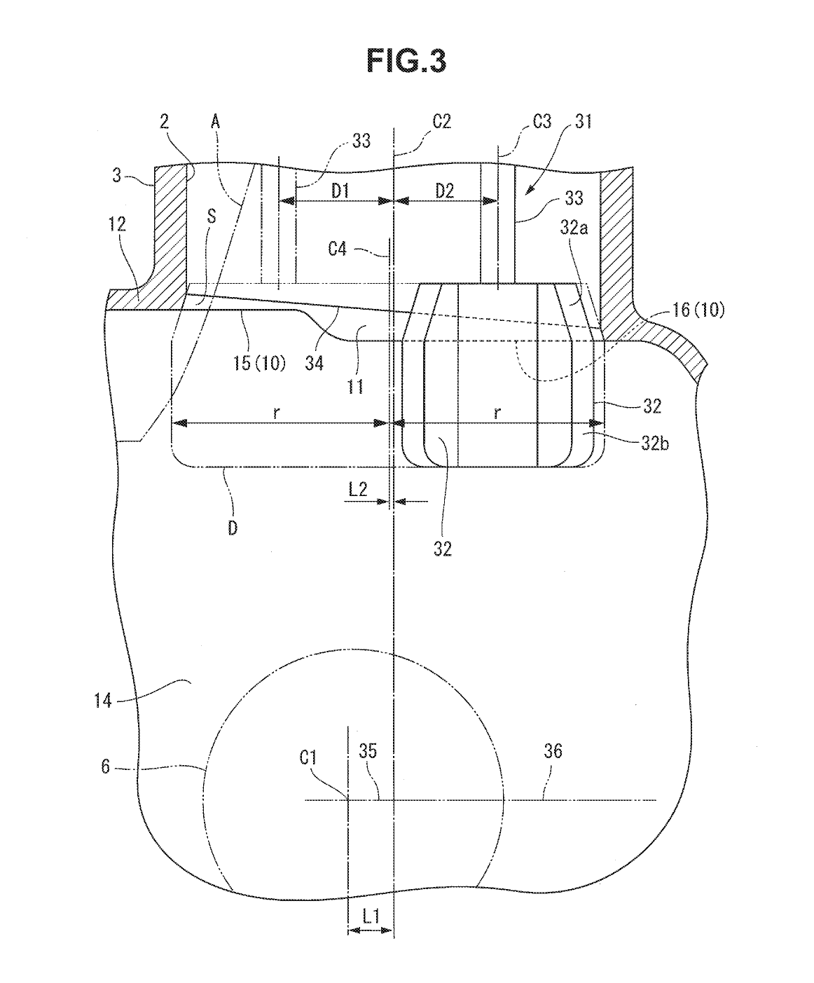

As shown in FIGS. 1 to 3 and 7, a portion connecting the ceiling wall 12 and the crank-shaft-side end of the cylinder wall 3, in other words, a portion surrounding the crank-shaft-side opening edge 10 of the cylinder hole 2 is defined by a first wall 15 positioned on the offset side, and a second wall 16 positioned on the other side. The first and second walls 15 and 16 are made into a predetermined shape by a mold for casting the cylinder block 1. As will be described in detail below, the first wall 15 does not contribute to guiding of the piston 4, and hence is positioned closer to the cylinder head side than the second wall 16. As shown in FIG. 3, since the first wall 15 is biased toward the cylinder head side, a space S is created between the moving locus of the connecting rod 5 indicated by the alternate long and two short dashed line A and the first wall 15 (the crank-shaft-side opening edge 10 of the cylinder hole 2), when viewed in the axial direction of the crank shaft 6. Note that the length of the first wall 15 is spaced apart from the second wall 16 toward the cylinder head side in the direction parallel or substantially parallel to the center axis C2 of the cylinder hole 2 and is a length which does not affect the function of guiding a skirt 4a (see FIG. 2) of the piston 4 by the wall surface of the cylinder hole 2.

As shown in FIG. 1, the third functional portion is a bearing wall 17 extending from the ceiling wall 12 toward the crank shaft 6. As shown in FIG. 1, the bearing portion 17 includes a plate-shaped portion 17a extending in a direction perpendicular or substantially perpendicular to the axis of the crank shaft 6, and a bearing portion 17b in the crank-shaft-side end of the plate-shaped portion 17a.

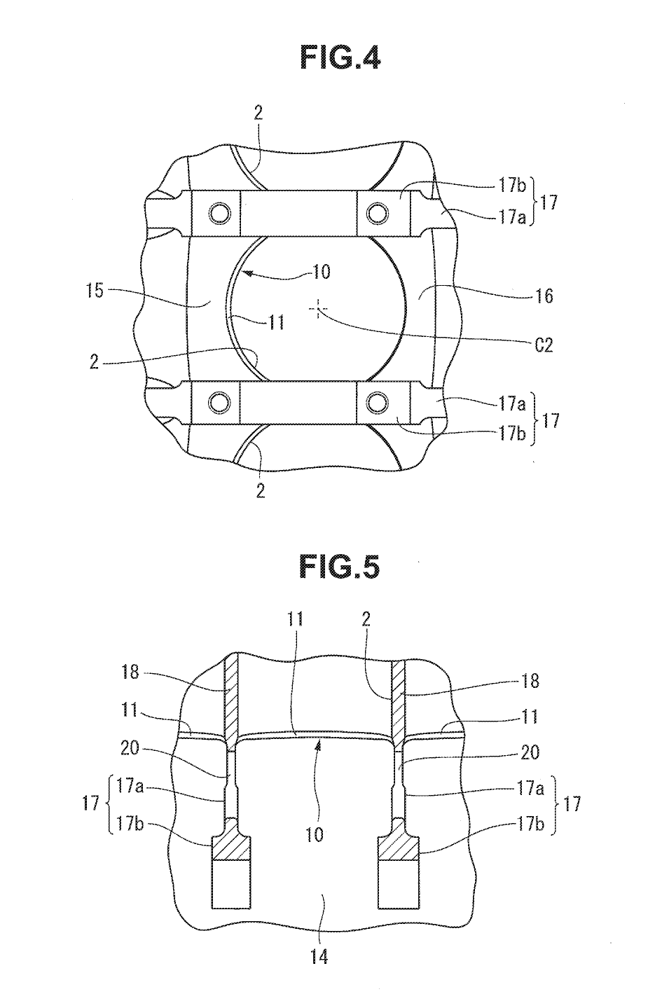

As shown in FIG. 4, the bearing wall 17 is located between the cylinder holes 2 that are adjacent to each other when viewed in the direction parallel or substantially parallel to the center axis C2 of the cylinder hole 2. As shown in FIG. 5, the plate-shaped portion 17a of the bearing wall 17 has a thickness equal or substantially equal to that of a partition 18 between the cylinder holes 2. The partition 18 defines a portion of the cylinder wall 3.

As shown in FIG. 1, a plurality of reinforcing ribs 19 are integral with the plate-shaped portion 17a according to the present preferred embodiment. Also, the plate-shaped portion 17a has a size which partitions the crank chamber 14 for the individual cylinders. First to third communication holes 20 to 22 which allow the inner spaces of the crank chamber 14, which are partitioned for the individual cylinders, to communicate with each other are provided in the plate-shaped portion 17a.

A honing stone escape portion 23 is provided in the cylinder-head-side end of the plate-shaped portion 17a, which overlaps the center axis C2 of the cylinder hole 2 when viewed in the axial direction of the crank shaft 6 as shown in FIG. 1. The honing stone escape portion 23 is a recess that avoids contact with a honing stone 24 inserted into the cylinder hole 2 to perform honing. The honing stone escape portion 23 is formed when chamfering (to be described below) the crank-shaft-side opening edge 10 of the cylinder hole 2. The honing stone escape portion 23 and a chamfered portion (to be described below) are preferably made using a sand core during casting. However, the surfaces are rough as cast and may damage the piston 4, so cutting is performed on them.

As shown in FIG. 5, the bearing portion 17b is preferably thicker than the plate-shaped portion 17a. As shown in FIG. 4, therefore, the bearing portion 17b partially overlaps the cylinder hole 2 when viewed in the direction parallel or substantially parallel to the center axis C2 of the cylinder hole 2. As shown in FIG. 1, a bearing cap 25 is attached to the bearing portion 17b. The crank shaft 6 is sandwiched between the bearing portion 17b and the bearing cap 25 and rotatably supported by these members.

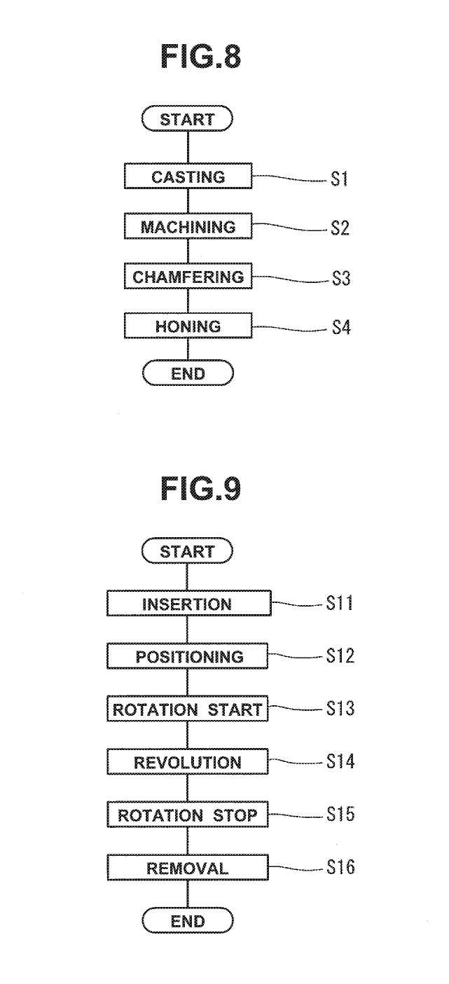

As shown in a flowchart of FIG. 8, chamfering on the crank-shaft-side opening edge 10 of the cylinder hole 2 is performed in chamfering step S3 after casting step S1 and machining step S2. The flowchart of FIG. 8 shows one non-limiting example of a method of manufacturing the cylinder block 1. The cylinder block 1 is manufactured by performing casting step S1, chamfering step S3, and honing step S4 in this order, for example. Casting step S1 is a step of molding the cylinder block 1 by casting. Machining step S2 is a step of cutting mating surfaces, passages, holes, and the like by machining, and performing threading. Machining step S2 includes prepared hole machining before honing.

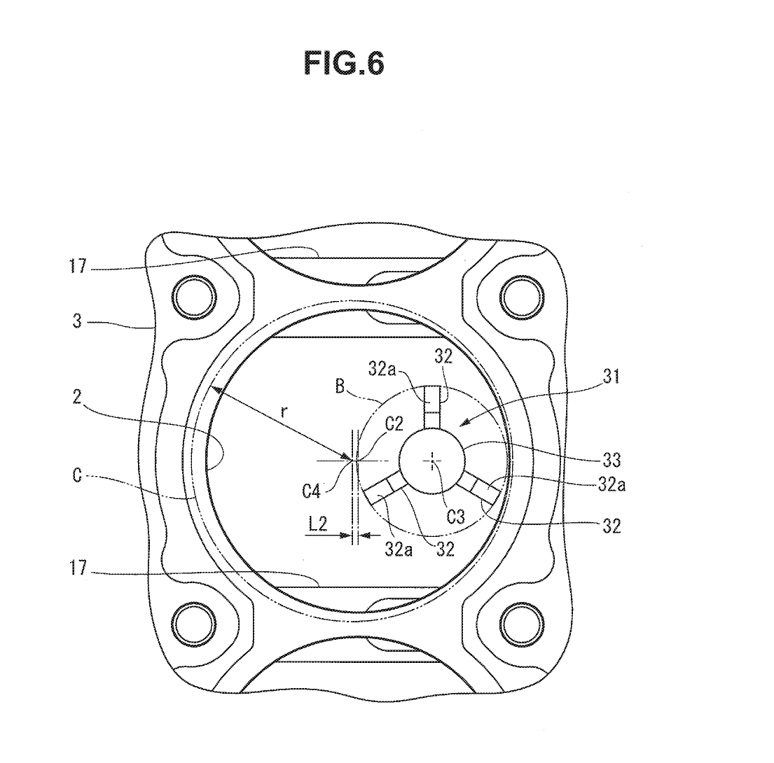

Chamfering step S3 is performed by using a cutter 31 shown in FIGS. 3 and 6. The cutter 31 includes a plurality of blades 32, and a rotational shaft 33 that supports the blades 32. The rotational shaft 33 is driven by a driving device (not shown), and rotates around an axis C3 (see FIG. 3) parallel or substantially parallel to the center axis C2 of the cylinder hole 2.

The cutter 31 shown in FIGS. 3 and 6 preferably includes three blades 32. However, the number of blades 32 is not limited to three and may be changed as needed. The plurality of blades 32 preferably extend, e.g., in the radial direction from the rotational shaft 33. Also, the blades 32 have a size which are able to be inserted into the cylinder hole 2 from the cylinder-head-side end.

When the cutter 31 rotates around the rotational shaft 33, the rotation locus defines a circle smaller than the cylinder hole 2 as indicated by an alternate long and two short dashed line B in FIG. 6 when viewed in the axial direction of the rotational shaft 33.

As shown in FIG. 3, the blade 32 has a predetermined length in the direction parallel or substantially parallel to the center axis C2 of the cylinder hole 2, and includes an inclining chamfering portion 32a on the cylinder head side, and an escape processing portion 32b extending toward the other end from the chamfering portion 32a.

The chamfering portion 32a is gradually inclined toward the other end of the blade 32 in the direction away from the axis C3 of the cutter 31. The escape processing portion 32b extends parallel or substantially parallel to the center axis C2 of the cylinder hole 2. The length of the escape processing portion 32b preferably matches the size and reciprocation stroke of the honing stone 24 to be used in honing step S4 after the chamfering step S3. The length of the escape portion 32b is desirably larger than the length the honing stone 24 projects toward the crank shaft 6 from the cylinder hole 2.

In the chamfering step S3, a plurality of steps shown in a flowchart of FIG. 9 are executed in order. When performing chamfering step S3, insertion step S11 is first performed, i.e., the cutter 31 is inserted into the cylinder hole 2 from the opening of the cylinder-head-side end. In positioning step S12, the cutter 31 is positioned such that the chamfered portion 32a is positioned in the boundary between the cylinder hole 2 and the crank chamber 14, as shown in FIG. 3. Note that FIG. 3 shows the cylinder block 1 in a state after chamfering step S3.

Subsequently, in rotation start step S13, the driving device drives the rotational shaft 33, and the cutter 31 rotates around the rotational shaft 33.

In revolution step S14 after that, the cutter 31 moves along a predetermined moving path. This movement is performed by the driving device by changing the position of the rotational shaft 33 in the direction perpendicular or substantially perpendicular to the center axis C2 of the cylinder hole 2.

When viewed in the axial direction of the rotatable shaft 33, the moving path of the cutter 31 is a path by which a circle indicated by an alternate long and two short dashed line C in FIG. 6 is the moving locus. When viewed in the axial direction of the crank shaft 6, this moving path is a path which defines a moving locus indicated by an alternate long and two short dashed line D in FIG. 3. A center C4 of the circle indicated by the alternate long and two short dashed line C in FIG. 6 is in the same position as that of the center (the position of the center axis C2) of the cylinder hole 2 in the axial direction of the crank shaft 6, and spaced apart by a length L2 toward the offset side (the left side in FIG. 6) from the center of the cylinder hole 2. As shown in FIG. 3, a radius r of the circle as the moving locus indicated by the alternate long and two short dashed line C in FIG. 6 is set to be a radius by which the chamfering portion 32a of the blade 32 is able to cut the crank-shaft-side opening edge 10 of the cylinder hole 2 on the offset side (the left side in FIG. 3) and on the opposite side.

As shown in FIG. 3, when viewed in the axial direction of the crank shaft 6, the moving amount of the rotation center (the position of the axis C3) of the cutter 31 which moves in revolution step S14 is D1 on the offset side (the left side in FIG. 3), and D2 on the other side, with respect to the center axis C2 of the cylinder hole 2. The moving amount D1 is larger than the moving amount D2. That is, the rotation center of the cutter 31 moves to the offset side longer than to the other side with respect to the center axis C2 of the cylinder hole 2.

As described above, since the cutter 31 in a rotating state moves (revolves) to define the moving locus indicated by the alternate long and two short dashed line C in FIG. 6, the chamfering portion 32a cuts the crank-shaft-side opening edge 10 of the cylinder hole 2 over the entire circumference. When revolution step S14 is performed, therefore, the cutter 31 moves along the crank-shaft-side opening edge 10 of the cylinder hole 2, and chamfers the whole crank-shaft-side opening edge 10. Since the crank-shaft-side opening edge 10 of the cylinder hole 2 is thus chamfered, the inclined surface 11 is provided on the opening edge over the entire circumference.

A boundary line 34 between the inclined surface 11 and the cylinder hole 2 inclines upward to the left in FIG. 3. As shown in FIG. 2, the inclining direction of the boundary line 34 is a direction in which the boundary line 34 gradually extends towards the opening 2a in the other end of the cylinder hole 2 toward the offset side on which the crank shaft 6 is offset from the center axis C2 of the cylinder hole 2, when viewed in the axial direction of the crank shaft 6. In other words, the inclining direction of the boundary line 34 is a direction in which, as shown in FIG. 3, the boundary line 34 extends towards a virtual line 36 including a perpendicular line 35 extending from the axis C1 of the crank shaft 6 to the center axis C2 of the cylinder hole 2, in the direction from the offset side to the other side (the right side in FIG. 3) when viewed in the axial direction of the crank shaft 6.

As described above, the end on the offset side of the boundary line 34 of the inclined surface 11 extends towards the opening 2a in the other end of the cylinder hole 2. This increases the spacing between the crank-shaft-side opening edge 10 of the cylinder hole 2 and the connecting rod 5.

The width (the width in the vertical direction in FIG. 3) of the inclined surface 11 in the direction parallel or substantially parallel to the center axis C2 of the cylinder hole 2 gradually increases toward the offset side. The reason for this is that the inclined chamfering portion 32a of the cutter 31 gradually cuts the crank-shaft-side opening edge 10 on the offset side deeply in the radial direction. Note that the first wall 15 is biased toward the cylinder head more than the second wall 16, so the width of the inclined surface 11 shown in FIG. 3 decreases halfway.

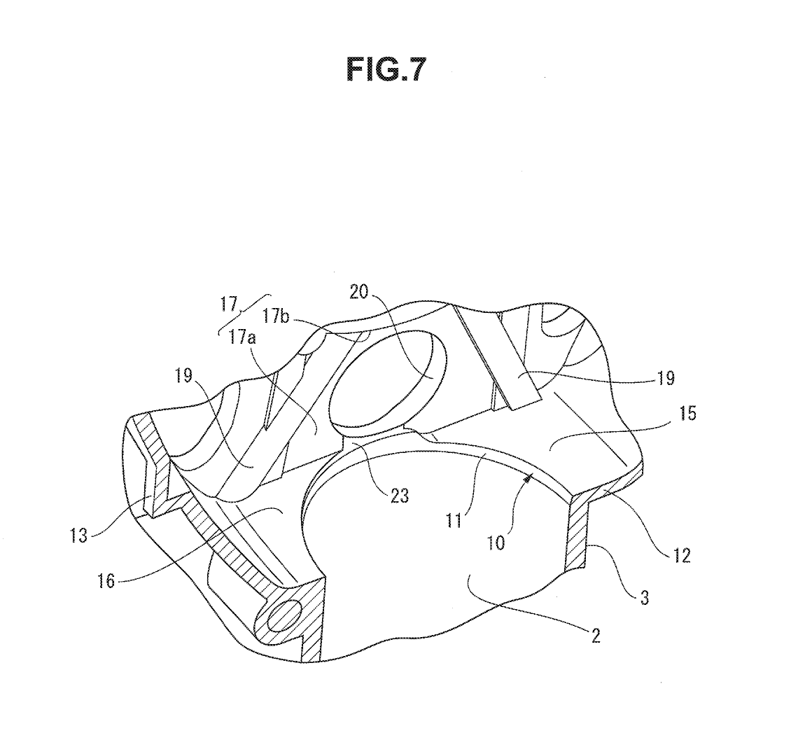

Also, since in revolution step S14 the cutter 31 moves along the moving locus indicated by the alternate long and two short dashed line C in FIG. 6, the bearing wall 17 is partially cut by the escape processing portion 32b of the cutter 31, thus creating the honing stone escape portion 23 on the bearing wall 17. That is, in revolution step S14, the above-described inclined surface 11 and the honing stone escape portion 23 of the bearing wall 17 are simultaneously processed by the cutter 31. As shown in FIGS. 1 and 7, the processed inclined surface 11 is connected to the honing stone escape portion 23.

After the cutter 31 revolves at least once along the above-described moving locus in revolution step S14, the process advances to rotation stop step S15, and the driving device stops driving the rotational shaft 33, thus stopping the cutter 31. In removal step S16 after that, the cutter 31 is moved from the position in which rotation is stopped to a removal position on the side of the center axis C2 of the cylinder hole 2, and removed to outside the cylinder block 1 through the cylinder hole 2. Chamfering step S3 is complete when the cutter 31 has thus retracted.

As shown in FIG. 8, honing step S4 is performed after chamfering step S3. In honing step S4, the honing stone 24 moves back and forth in the cylinder hole 2 while rotating. In the present preferred embodiment, the honing stone 24 does not interfere with the bearing wall 17 because the honing stone escape portion 23 is provided on the bearing wall 17.

In the present preferred embodiment, as shown in FIGS. 1 to 3, the inclined surface 11 on the crank-shaft-side opening edge 10 of the cylinder hole 2 is gradually inclined toward the opening 2a in the other end (the cylinder head side) of the cylinder hole 2 in the direction of the offset side, when viewed in the axial direction of the crank shaft 6. The end of the inclined surface 11 on the offset side is also a portion to which the connecting rod 5 comes closest. The boundary line 34 of the inclined surface 11 is close to the opening in the other end of the cylinder hole 2, and this increases the spacing between the crank-shaft-side opening edge 10 of the cylinder hole 2 and the connecting rod 5. This makes it possible to avoid interference between the crank-shaft-side opening edge 10 of the cylinder hole 2 and the connecting rod 5 by the inclined surface 11.

Also, the above-described boundary line 34 indicates a position corresponding to the limit of the range within which the piston 4 is guided near bottom dead center. That is, since only the guide of the piston 4 near bottom dead center gradually reduces toward the offset side, the posture of the piston 4 does not become unstable near the bottom dead center.

Furthermore, in the present preferred embodiment, the whole circumference of the crank-shaft-side opening edge 10 of the cylinder hole 2 is chamfered. Therefore, the skirt 4a of the piston 4 passing through this opening edge is not damaged by burrs or small projections.

Accordingly, the present preferred embodiment is able to provide an offset crank engine in which the whole circumference of the crank-shaft-side opening edge 10 of the cylinder hole 2 is chamfered without any adverse influence so as to avoid interference between the crank-shaft-side opening edge 10 of the cylinder hole 2 and the connecting rod 5. Without any adverse influence includes avoiding a bad influence on the sliding surface or the posture of the piston 4, e.g., the creation of a recess in the crank-shaft-side opening edge or raising the position of the crank-shaft-side opening edge over the entire circumference as in a conventional arrangement.

The inclined surface 11 according to the present preferred embodiment is connected to the honing stone escape portion 23. This makes it possible to reliably prevent contact with the bearing wall 17 when the piston 4 or honing stone 24 projects toward the crank shaft 6 from the cylinder hole 2.

In the present preferred embodiment, therefore, the bearing wall 17 is close to the center axis C2 of the cylinder 2 while avoiding interference with the piston 4 or honing stone 24, so the cylinder block 1 is shortened in the axial direction of the crank shaft 6. Consequently, the present preferred embodiment is able to provide an engine that is compact in the axial direction of the crank shaft 6.

In the present preferred embodiment, the piston 4 does not come into contact with the portion of the cylinder hole 2 that is closer to the crank shaft side than the boundary line 34 of the inclined surface 11 and, thus, the portion has no function of guiding the piston 4 near bottom dead center. In the cylinder block 1 of the present preferred embodiment, the first is position biased to the cylinder head side more than the second wall 16.

This structure shortens the time required for the cutting process when machining the inclined surface 11 compared to an arrangement in which the first wall 15 and second wall 16 have the same height, so the productivity increases.

Chamfering according to the present preferred embodiment is performed by using the cutter 31 having a diameter smaller than the diameter of the cylinder hole 2. Therefore, the cutter 31 is inserted into the cylinder hole 2 from the cylinder-head-side opening of the cylinder hole 2, and hence is positioned with high accuracy by using the cylinder-head-side mating surface 8 of the cylinder block 1. As a consequence, the crank-shaft-side opening edge 10 of the cylinder hole 2 is accurately chamfered.

Chamfering step S3 according to the present preferred embodiment is preferably performed by using the cutter 31 having a predetermined length in the direction parallel or substantially parallel to the center axis C2 of the cylinder 2. In the chamfering step S3, the crank-shaft-side opening edge 10 of the cylinder 2 and the bearing wall 17 are simultaneously processed by the cutter 31.

In the present preferred embodiment, therefore, it is possible to efficiently perform chamfering on the crank-shaft-side opening edge 10 of the cylinder hole 2 and, thus, the honing stone escape portion 23 on the bearing wall 17. This makes it possible to provide a highly productive engine cylinder block manufacturing method.

### Second Preferred Embodiment

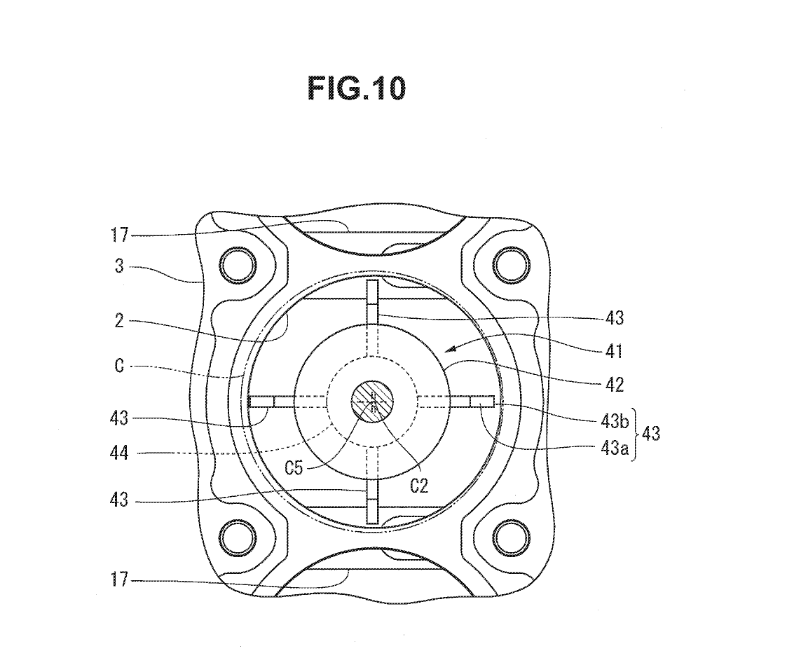

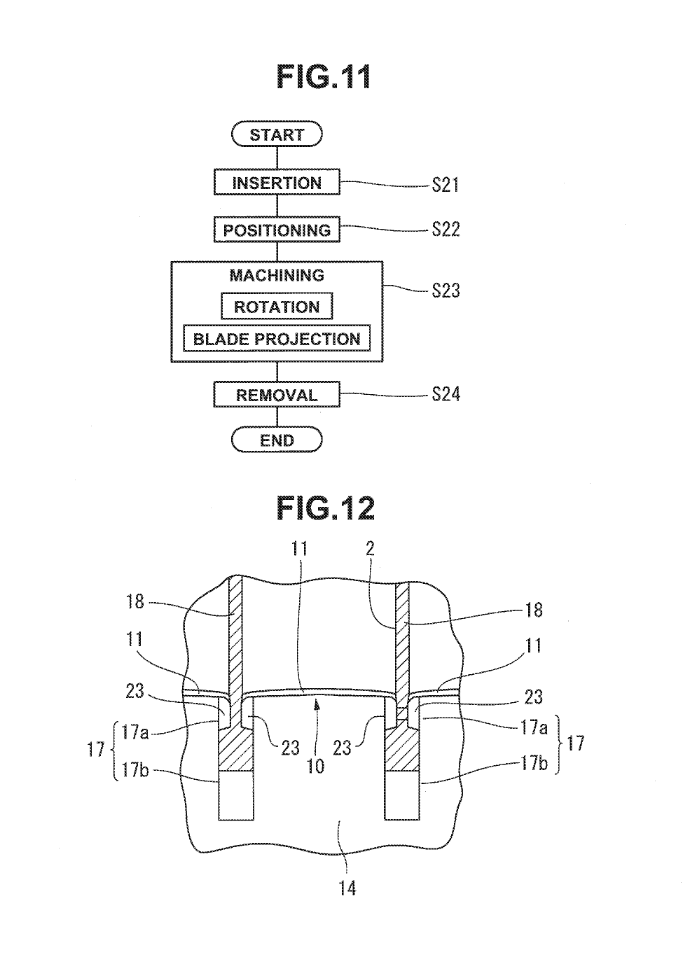

The chamfering step (chamfering and the processing of the honing stone escape portion) is also able to be performed as shown in FIGS. 10 and 11. Referring to FIGS. 10 and 11, the same reference numerals as in FIGS. 1 to 9 denote the same members as explained with reference to FIGS. 1 to 9 or similar members, and a detailed explanation thereof will suitably be omitted.

In a cutter 41 (see FIG. 10) used in the chamfering step S3 according to the present preferred embodiment, a plurality of blades 43 radially projecting from a rotatable shaft 42 move in the radial direction of the rotatable shaft 42.

An axis C5 of the rotatable shaft 42 is in a processing position spaced apart by a predetermined length to the offset side (the left side in FIG. 10) from a center axis C2 of a cylinder hole 2, and the rotatable shaft 42 rotates by being driven by a driving device (not shown) in this processing position.

Although details are not shown in the drawings, the plurality of blades 43 include a chamfering portion 43a and an escape processing portion 43b similar to the blade 32 disclosed in the first preferred embodiment. The blades 43 are pushed outward in the radial direction by a pushing mechanism 44 in the rotatable shaft 42, and project outward in the radial direction from the rotatable shaft 42 while being supported by the rotatable shaft 42. As the pushing mechanism 44, it is possible to use, e.g., a pushing mechanism disclosed in Japanese Patent Laid-Open No. 2015-161189.

Chamfering step S3 according to the present preferred embodiment is preferably performed as shown in a flowchart of FIG. 11. When performing the chamfering step S3, the cutter 41 is first inserted into the cylinder hole 2 from the cylinder head side (insertion step S21), and positioned in the boundary portion between the cylinder hole 2 and a crank chamber 14 (positioning step S22). In the positioning step S22, the rotatable shaft 42 of the cutter 41 is positioned in the above-described processing position.

In machining step S23 after the positioning step S22, the cutter 41 rotates and the blades 43 project outward in the radial direction from the rotatable shaft 42. Since the blades 43 project from the rotatable shaft 42, the rotating blades 43 cut a crank-shaft-side opening edge 10 of the cylinder hole 2, thus forming an inclined surface 11. This chamfering is performed in a state in which the rotation center (the axis C5) of the cutter 41 is stopped in a position biased to the offset side from the center axis C2 of the cylinder hole 2.

Also, in the machining step S23, the escape processing portion 43b of the blade 43 cuts a bearing wall 17, thus forming a honing stone escape portion 23 on the shaft wall 17. An alternate long and two short dashed line D in FIG. 3 indicates the outer shape of the cutter 41 when this machining is complete.

After the machining step S23 is complete, the rotation of the cutter 41 stops, and the blades 43 of the cutter 41 retract inward in the radial direction of the rotatable shaft 42. Then, in removal step S24, the cutter 41 is removed outside the cylinder block 1 through the cylinder hole 2. Chamfering step S3 is complete when the cutter 41 is retracted.

When compared to the method according to the first preferred embodiment of performing chamfering while moving the cutter 41, the present preferred embodiment is able to shorten the processing time because the position of the cutter 41 remains unchanged. Therefore, the present preferred embodiment provides a highly productive engine cylinder block manufacturing method.

### Third Preferred Embodiment

Preferred embodiments of the present invention are also applicable to an engine including a cylinder block made by aluminum die casting. FIG. 12 shows a bearing wall 17 of a cylinder block 1 made by aluminum die casting. Referring to FIG. 12, the same reference numerals as in FIGS. 1 to 9 denote the same members as explained with reference to FIGS. 1 to 9 or similar members, and a detailed explanation thereof will suitably be omitted.

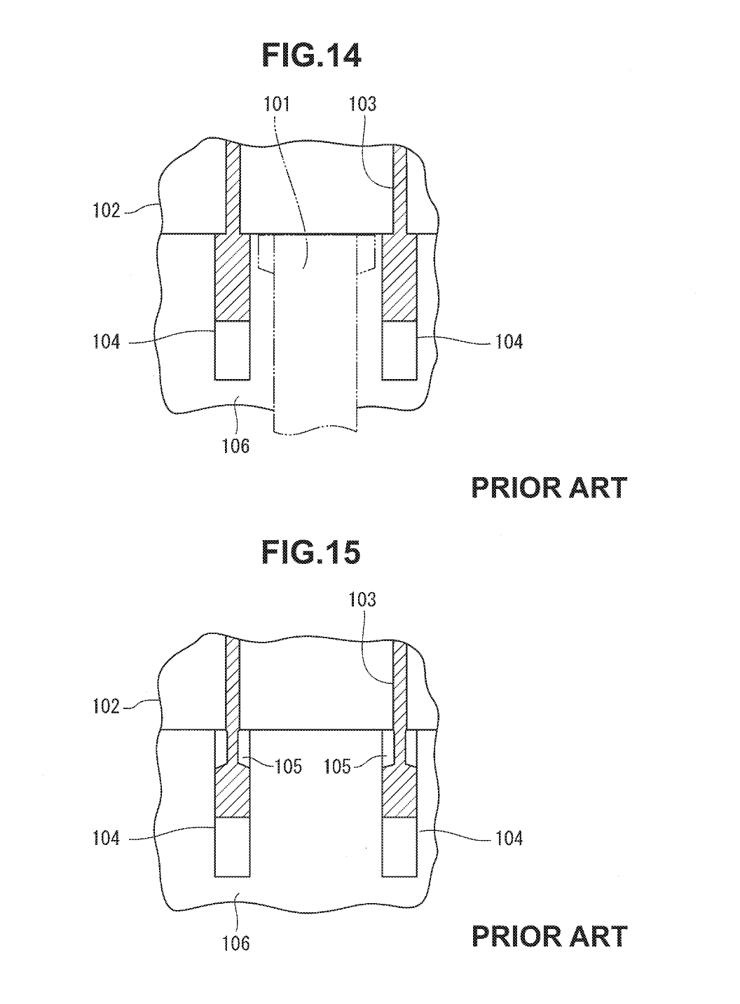

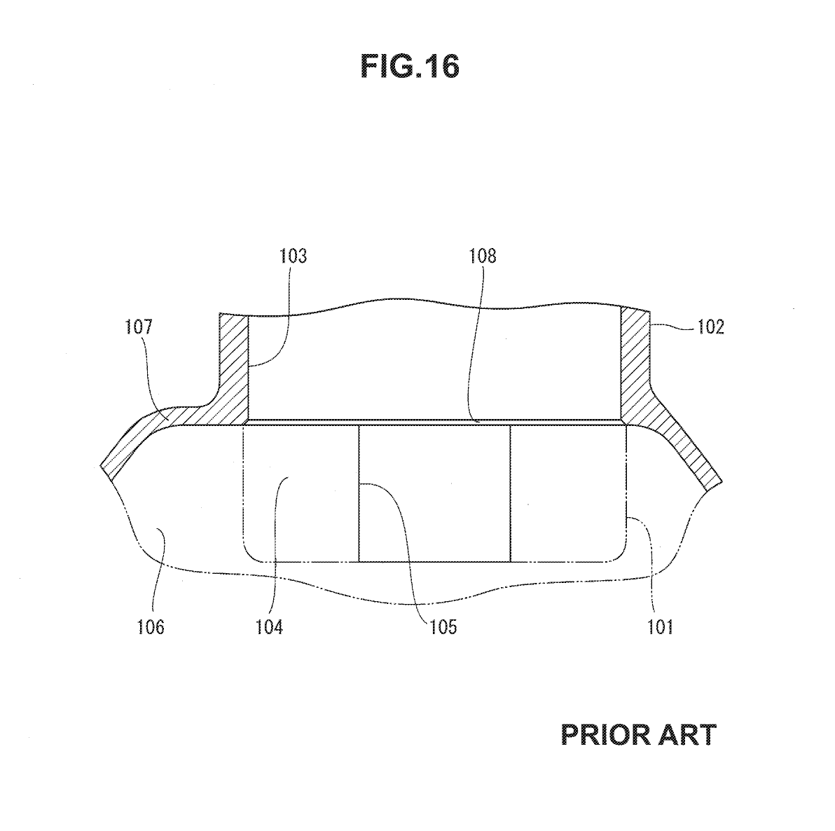

Immediately after die casting, a plate-shaped portion 17a of the bearing wall 17 shown in FIG. 12 has a shape releasable from a metal mold, as explained with reference to FIG. 14 of the related art at the beginning of this specification, and has a thickness equal to or larger than that of a bearing portion 17b. A honing stone escape portion 23 is provided on the plate-shaped portion 17a by being cut by a cutter (not shown) as explained in the first or second preferred embodiment of the present invention. Also, an inclined surface 11 is provided on a crank-shaft-side opening edge 10 of a cylinder hole 2.

Preferred embodiments of the present invention are thus also applicable to an engine including the cylinder block 1 made by aluminum die casting, and are able to achieve the same effects as those obtained by the above-described preferred embodiments.

### Fourth Preferred Embodiment

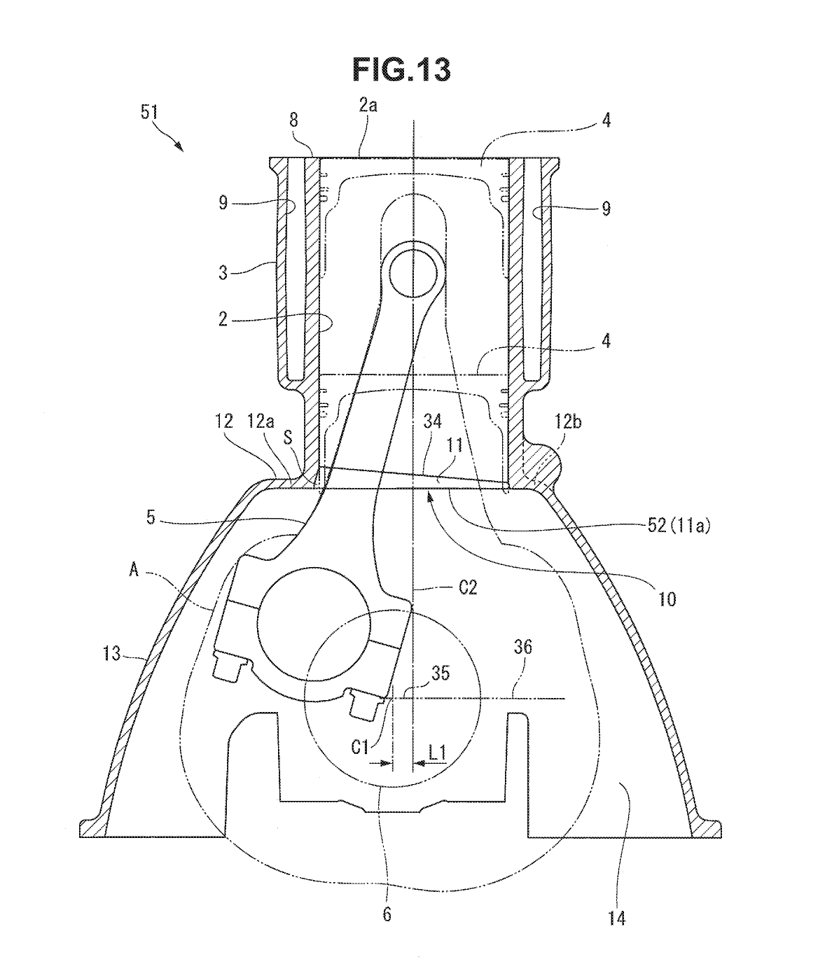

A preferred embodiment of the present invention also includes the structure shown in FIG. 13. Referring to FIG. 13, the same reference numerals as in FIGS. 1 to 12 denote the same members as explained with reference to FIGS. 1 to 12 or similar members, and a detailed explanation thereof will suitably be omitted.

In a cylinder block 51 shown in FIG. 13, a portion surrounding a crank-shaft-side opening edge 10 of a cylinder hole 2 differs from that of the cylinder block 1 according to the above-described preferred embodiments, and the rest is preferably the same.

The portion surrounding the crank-shaft-side opening edge 10 of the cylinder hole 2 is defined by a flat third wall 52. The thickness of the third wall 52 is preferably constant.

Accordingly, a ceiling wall 12 of a crank case 13 has the same or substantially the same height at one end 12a as the offset side and at the other end 12b, when viewed in the axial direction of a crank shaft 6. The “height” herein refers to a position in a direction parallel or substantially parallel to a center axis C2 of the cylinder hole 2.

Also, since the third wall 52 is flat, an edge 11a of an inclined surface 11 on the crank shaft side linearly extends between the offset side and the other side when viewed in the axial direction of the crank shaft 6. The inclined surface 11 may be made by a cutter (not shown) as explained in the first or second preferred embodiments of the present invention.

Even when the crank-shaft-side opening edge 10 of the cylinder hole 2 opens to the flat third wall 52 as described above, a space S is defined between the inclined surface 11 and a connecting rod 5, so interference between the cylinder hole 2 and the connecting rod 5 is avoided. Consequently, the same effects as those obtained by the above-described preferred embodiments are obtained.

In a preferred embodiment of the present invention, the connecting rod comes closest to the end of the inclined surface on the offset side. The boundary line of this inclined surface is close to the opening in the other end of the cylinder hole, and this increases the spacing between the crank-shaft-side opening edge of the cylinder hole and the connecting rod. The inclined surface makes it possible to avoid interference between the crank-shaft-side opening edge of the cylinder hole and the connecting rod.

Also, the above-described boundary line indicates a position corresponding to the limit of the range within which the piston is guided near bottom dead center. That is, since only the guide of the piston near bottom dead center gradually reduces toward the offset side, the posture of the piston does not become unstable near bottom dead center.

Furthermore, in a preferred embodiment of the present invention, the whole circumference of the crank-shaft-side opening edge of the cylinder hole is chamfered. Therefore, the skirt of the piston passing through this opening edge is not damaged by burrs or fine projections.

Accordingly, preferred embodiments of the present invention are able to provide an offset crank engine in which the whole circumference of the crank-shaft-side opening edge of the cylinder hole is chamfered without any adverse influence on the sliding surface or the posture of the piston, e.g., the creation of a recess in the crank-shaft-side opening edge or raising the position of the crank-shaft-side opening edge over the entire circumference as in a conventional arrangement, thus avoiding interference between the crank-shaft-side opening edge of the cylinder hole and the connecting rod.

In an engine cylinder block manufacturing method which performs chamfering by moving a rotating cutter along the crank-shaft-side opening edge of the cylinder hole, a cutter having a diameter smaller than that of the cylinder hole is preferably used. Therefore, since the cutter is inserted into the cylinder hole from the opening of the cylinder hole that is opposite to the crank shaft, the cutter is able to be positioned with high accuracy by using the cylinder-head-side mating surface of the cylinder block. As a consequence, the crank-shaft-side opening edge of the cylinder hole is accurately chamfered.

In a cylinder block manufacturing method which performs chamfering by rotating a cutter in a state in which the rotation center of the rotating cutter is stopped in a position biased in the offset direction of the crank shaft from the center axis of the cylinder hole, the processing time is shortened compared to a method of performing chamfering while moving the cutter. This makes it possible to provide a highly productive method of manufacturing an engine cylinder block.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An engine comprising:
a cylinder block including a cylinder hole into which a piston is movably fitted;
a crank shaft including an axis offset from a center axis of the cylinder hole; and
a connecting rod that connects the piston and the crank shaft to each other; wherein
an inclined surface is provided along an entire circumference of a crank-shaft-side opening edge of a first end of the cylinder hole; and
when viewed in an axial direction of the crank shaft, a boundary line between the inclined surface and the cylinder hole extends towards a second end of the cylinder hole as the inclined surface extends toward an offset side of the cylinder hole at which the crank shaft is offset from the center axis.

2. The engine according to claim 1, wherein the cylinder block includes:
a cylinder wall including the cylinder hole;
a crank case including a ceiling wall connected to the cylinder wall and defining a crank chamber; and
a bearing wall that extends from the ceiling wall to the crank shaft, and supports a cylinder-side half of the crank shaft; wherein
a honing stone escape portion is provided on the bearing wall, the honing stone escape portion allowing a honing stone to be inserted into the cylinder hole without contacting the bearing wall; and
the inclined surface is connected to the honing stone escape portion.

3. A method of manufacturing a cylinder block of an engine, the engine including a cylinder block including a cylinder hole into which a piston is movably fitted, and a crank shaft including an axis offset from a center axis of the cylinder hole, the method comprising the steps of:
chamfering an entire circumference of a crank-shaft-side opening edge of a first end of the cylinder hole using a cutter that rotates around an axis parallel or substantially parallel to the center axis while moving the cutter along the crank-shaft-side opening edge; wherein
an amount that a rotation center of the cutter moves in the step of chamfering is larger on a first side of the cylinder hole at which the crank shaft is offset from the center axis of the cylinder hole than on a second side of the cylinder hold, when viewed in a direction of the axis of the crank shaft.

4. A method of manufacturing a cylinder block of an engine, the engine including a cylinder block including a cylinder hole into which a piston is movably fitted, and a crank shaft including an axis offset from a center axis of the cylinder hole, the method comprising the steps of:
chamfering an entire circumference of a crank-shaft-side opening edge of a first end of the cylinder hole using a cutter that rotates around an axis parallel or substantially parallel to the center axis while a rotation center of the cutter stays in a position biased in an offset direction of the crank shaft with respect to the center axis.

5. The method according to claim 3, wherein
the cylinder block includes a cylinder wall including the cylinder hole, a crank case including a ceiling wall connected to the cylinder wall to define a crank chamber, and a bearing wall that extends from the ceiling wall to the crank shaft and supports a cylinder-side half of the crank shaft;
the cutter has a predetermined length in a direction parallel or substantially parallel to the center axis; and
during the step of chamfering, the opening edge and the bearing wall are simultaneously processed by the cutter.
